(19) United States
(12) Patent Application Publication
(10) Pub. No.: US 2013/0074764 A1
(43) Pub. Date: Mar. 28, 2013

(54) FILM-FORMING APPARATUS AND MANUFACTURING METHOD FOR SEMICONDUCTOR DEVICE

(71) Applicants: Haruhiko Ishihara, Yokohama-shi (JP); Tsuyoshi Sato, Yokohama-shi (JP); Kenechi Ooshiro, Yokohama-shi (JP)

(72) Inventors: Haruhiko Ishihara, Yokohama-shi (JP); Tsuyoshi Sato, Yokohama-shi (JP); Kenechi Ooshiro, Yokohama-shi (JP)

(21) Appl. No.: 13/605,205

(22) Filed: Sep. 6, 2012

(30) Foreign Application Priority Data
Sep. 26, 2011 (JP) 2011-208428

(51) Int. Cl. B05C 11/00; B05C 11/02

(52) U.S. Cl. 118/66; 118/58

(57) ABSTRACT

According to one embodiment, a film-forming apparatus includes a coating unit which introduces a liquid material to a substrate with a groove and fills the liquid material into the groove, thereby forming a liquid layer, a drying unit which solidifies the liquid layer by drying, and a vapor supply unit which applies a vapor to a surface of the liquid layer during the drying

### CROSS-REFERENCE TO RELATED APPLICATIONS

This application is based upon and claims the benefit of priority from Japanese Patent Application No. 2011-208428, filed Sep. 26, 2011, the entire contents of which are incorporated herein by reference.

### FIELD

Embodiments described herein relate generally to a film-forming apparatus and a manufacturing method for a semiconductor device.

### BACKGROUND

In the field of semiconductor devices, a shallow-trench-isolation (STI) structure is widely used for isolation between fine elements. An STI-structure process comprises steps of forming trenches in a surface of a substrate, filling a solution into the trenches by applying it onto the substrate, and solidifying the solution into a film by drying.

A reduction in volume occurs during the drying, thus the grooved portions of the film are dented. Accordingly, the film thickness is reduced at, for example, groove shoulder portions.

### BRIEF DESCRIPTION OF THE DRAWINGS

FIG. 1 is an explanatory diagram showing a coating device of a film-forming apparatus according to a first embodiment;

FIG. 2 is an explanatory diagram showing a drying device of the film-forming apparatus;

FIG. 3 is a flowchart showing a film-forming method according to the first embodiment;

FIG. 4 is an explanatory diagram showing states of a substrate before and after coating according to the first embodiment;

FIG. 5 is an explanatory diagram showing states of the substrate before and after drying according to the first embodiment;

FIG. 6 is an explanatory diagram showing a drying device of a film-forming apparatus according to a second embodiment;

FIG. 7 is an explanatory diagram showing a drying device of a film-forming apparatus according to a third embodiment; and

FIG. 8 is an explanatory diagram showing states of a substrate before and after drying in an example of a film-forming method.

### DETAILED DESCRIPTION

### First Embodiment

In general, according to one embodiment, a film-forming apparatus comprises a coating unit, a drying unit, and a vapor supply unit. The coating unit introduces a liquid material to a substrate with a groove and fills the liquid material into the groove, thereby forming a liquid layer. The drying unit solidifies the liquid layer by drying. The vapor supply unit applies a vapor to a surface of the liquid layer during the drying.

A film-forming apparatus and a manufacturing method for a semiconductor device according to a first embodiment will now be described with reference to FIGS. 1 to 4. In these drawings, some structural elements are enlarged or reduced in scale or omitted for ease of illustration. The semiconductor device manufacturing method of the present embodiment comprises a method of forming an insulating film on a substrate 101 with trenches 101a. In the case of this embodiment, an insulating material for the insulating film is applied to the semiconductor substrate 101 with the trenches 101a, thereby filling the trenches, in a pretreatment process.

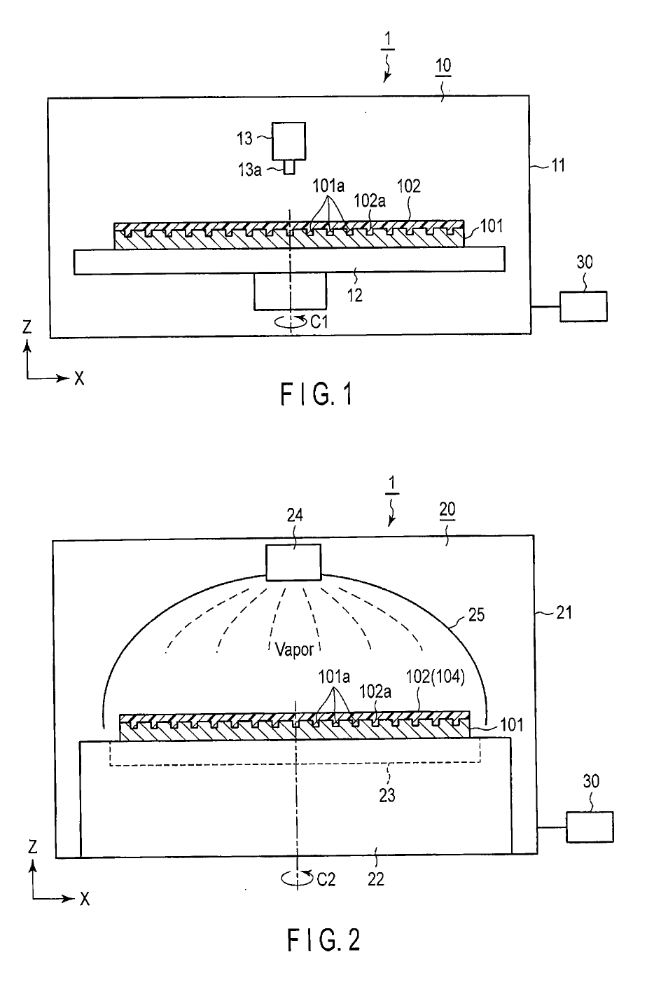

As shown in FIGS. 1 and 2, a film-forming apparatus 1 comprises a coating device 10, drying device 20, and control unit 30. The control unit 30 is connected to the devices 10 and 20 and controls the operation of various parts.

The coating device 10 shown in FIG. 1 comprises a coating chamber 11, stage 12, and coating head (coating unit) 13. The stage 12 supports the substrate 101 for rotation in the chamber 11. The coating head 13 comprises a nozzle 13a located above and opposite the stage 12.

The drying device 20 shown in FIG. 2 comprises a drying chamber 21, supporting portion 22, heater (drying unit) 23, vapor supply head (vapor supply unit) 24, and dome roof 25. The supporting portion 22 supports the substrate 101 in the chamber 21. The heater 23 is embedded in the supporting portion 22 and dries the substrate 101 by heating. The vapor supply head 24 supplies a vapor 103 of a solvent during the drying. The roof 25 serves to restrict the range of the vapor supply.

In the drying device 20, the substrate 101 set on the supporting portion 22 is dried by the heater 23, and the solvent vapor is injected from the vapor supply head 24 to improve the liquidity of the surface of a liquid layer 102 being dried.

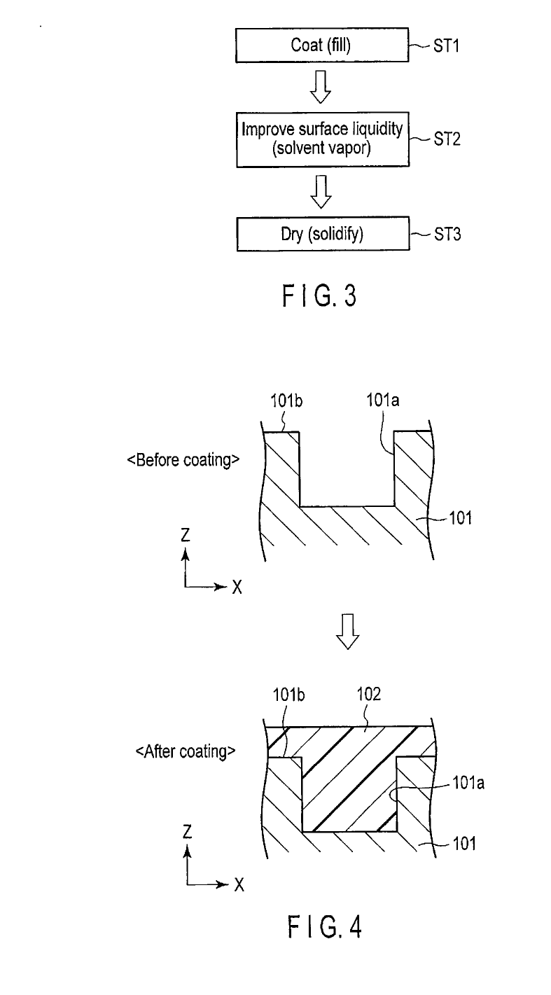

The semiconductor device manufacturing method according to the present embodiment will now be described with reference to FIG. 3. As shown in FIG. 3, a film-forming method comprises a coating process, liquidity improvement process, and drying process. In a pretreatment step, the trenches 101a are previously formed in the surface of the substrate 101. For example, the trenches 101a are grooves formed in a predetermined pattern.

In the coating process, as shown in FIG. 4, the liquid layer 102 is formed by applying a liquid material 102a to the substrate 101, and the liquid material 102a is filled into the trenches 101a.

In the coating process, the liquid material 102a is discharged from the nozzle 13a of the coating head 13 of the coating device 10 shown in FIG. 1 with the substrate 101 set on the stage 12. Thereafter, the liquid material 102a is introduced onto the substrate 101 by rotating the stage 12 about a central axis C1, whereupon the liquid layer 102 is formed on the substrate 101.

By this coating process, the liquid layer 102 consisting of the liquid material 102a is formed on the substrate 101, and the liquid material 102a is filled into the trenches 101a. After the coating process, the substrate 101 is delivered to the drying device 20, whereupon the drying process and liquidity improvement process are performed.

According to the present embodiment, a solvent vapor injection process is first performed as the liquidity improvement process immediately after the coating process, such that the solvent vapor is injected onto the surface of the liquid layer 102 on the substrate 101. The solvent used is one that is easily soluble in the liquid material 102a. The solvent for the insulating material may be, for example, gamma-butyrolactone or N-methyl-2-pyrrolidone.

In the solvent vapor injection process, the solvent vapor is injected from a nozzle of the vapor supply head 24 of the drying device 20 shown in FIG. 2 onto the surface of the liquid layer 102 with the substrate 101 set on the supporting portion 22. In this way, the liquidity of the surface of the liquid layer 102 is improved. When this is done, the vapor can be uniformly introduced onto the liquid layer 102 by rotating the supporting portion 22 about a rotary axis C2.

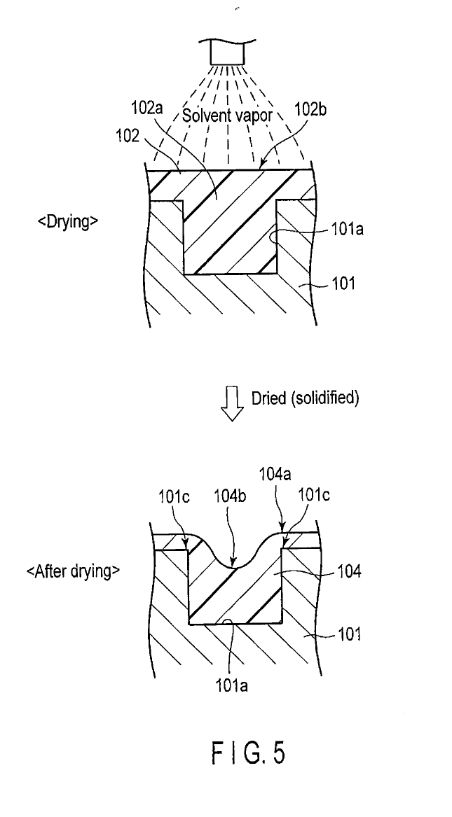

As shown in FIG. 5, moreover, the solvent vapor injection process is performed as the heater 23 of the drying device 20 is activated to heat the substrate 101, thereby solidifying the liquid material 102a, in a heating process. As this is done, the temperature of the heater 23 is changed in stages under the control of the control unit 30. For example, the heater temperature is controlled so that it is changed in stages from an initial low level to a high level. Thus, the volatilization speed of the solvent is reduced by drying the substrate 101 at the temperature that increases in stages. In this way, formation of a thin film portion is retarded when the volume is reduced.

The density and viscosity of the liquid material 102a on a surface 102b of the liquid layer 102 are reduced by the solvent vapor injection during the drying. Thus, the liquidity of the surface 102b of the liquid layer 102 increases, which slows down the solidification of surface 102b. As the drying speed of the liquid layer 102 is reduced at the surface during the drying in the solvent vapor injection process, the liquid layer 102 solidifies from the inside or underside.

By the drying process and liquidity improvement process, as shown in FIG. 5, the liquid material 102a is solidified to form an insulating material film 104. As this is done, the liquid material 102a is volatilized by heating and drying, whereupon a reduction in volume occurs. In some cases, the volume reduction may cause formation of a hollow 104b in a surface 104a of the film 104 in each trench 101a. By the solvent vapor injection, however, the liquid material on the surface is dried as it flows, so that the film thickness can be made uniform. As compared with the case where the surface solidifies first, therefore, the material becomes smoother as it solidifies. Thus, the thickness can be ensured even at shoulder portions 101c of each trench 101a where the film is easily thinned, in particular, so that formation of a thin film portion is retarded. Since the substrate 101 is rotated as the liquidity improvement process and drying process are performed, moreover, the vapor can be uniformly introduced, and the drying speed is constant.

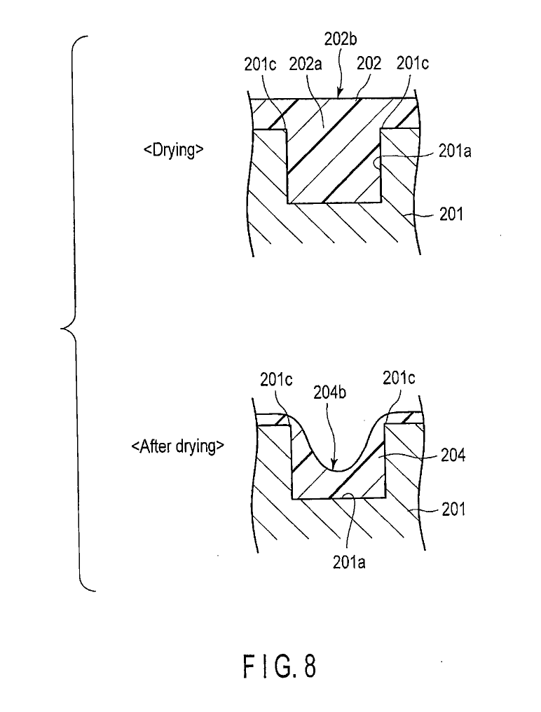

FIG. 8 shows states of a substrate 201 with trenches 201a where the drying process is performed without carrying out the liquidity improvement process after the coating process in which a liquid material 202a is applied to the substrate 201, as a control for comparison. In this case, the liquidity of the surface of a liquid layer 202 is so low that the liquid layer 202 solidifies from the surface in an early stage of the drying process. A hollow 204b deeper than the hollow 104b of the present embodiment shown in FIG. 5 is formed in the surface of an oxide film 204 formed after the drying, and the film thickness is reduced at stepped shoulder portions 201c, in particular.

According to the film-forming apparatus and semiconductor device manufacturing method (film-forming method) of the present embodiment, the liquidity is improved by the liquidity improvement process during the drying. Therefore, the film thickness can be ensured by controlling a volume reduction during the drying to achieve leveling such that the surface cannot be easily dented. Since the film thickness can also be ensured at stepped portions, such as the shoulder portions 101c of the trenches 101a where the film is easily thinned, in particular, such a problem as insulation failure can be avoided. Thus, it is unnecessary to apply an excessive amount of the liquid material 102a.

### Second Embodiment

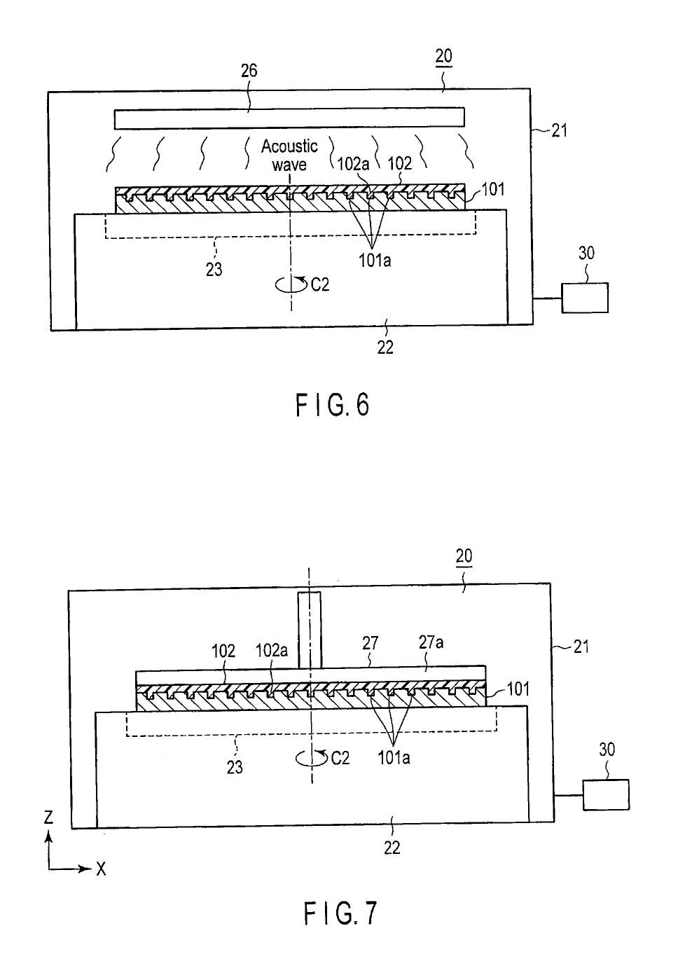

A film-forming apparatus and a semiconductor device manufacturing method (film-forming method) according to a second embodiment will now be described with reference to FIG. 6. The second embodiment differs from the first embodiment only in that acoustic radiation from an acoustic radiation head (acoustic radiation unit) 26 is performed in place of vapor injection as the liquidity improvement process, thus a description of common elements is omitted.

As shown in FIG. 6, a film-forming apparatus 1 according to the second embodiment comprises the acoustic irradiation head 26 in a chamber 21 of a drying device 20. In the drying device 20, a substrate 101 set on a supporting portion 22 is dried by a heater 23, and an acoustic wave from the acoustic irradiation head 26 is applied to the surface of a liquid layer 102 to improve its liquidity.

The present embodiment can provide the same effects as those of the first embodiment. Specifically, a reduction in volume may sometimes cause formation of a hollow 104b in a surface 104a of a film 104 in each of trenches 101a. Due to the acoustic radiation, however, a liquid material on the surface is dried as it flows, so that the film thickness can be made uniform. As compared with the case where the surface solidifies first, therefore, the material becomes smoother as it solidifies. Thus, the thickness can be ensured even at shoulder portions 101c of each trench 101a where the film is easily thinned, in particular, so that formation of a thin film portion is retarded. Since the substrate 101 is rotated as the liquidity improvement process and drying process are performed, moreover, the acoustic wave can be uniformly introduced, and a liquid material 102a can be smoothed by a centrifugal force.

### Third Embodiment

A film-forming apparatus and a semiconductor device manufacturing method (film-forming method) according to a third embodiment will now be described with reference to FIG. 7. The third embodiment differs from the first embodiment only in that the surface of a liquid layer 102 is smoothed by means of a smoothing device (smoothing unit) 27 in place of vapor injection as the liquidity improvement process, so that a description of common elements is omitted.

As shown in FIG. 7, a film-forming apparatus 1 according to the third embodiment comprises the smoothing device 27 in a chamber 21 of a drying device 20. The smoothing device 27 comprises a blade 27a, which is pressed against the surface of the liquid layer 102 as a substrate 101 is rotated about a rotary axis C2. The smoothing device 27 may be rotated instead. In the drying device 20, the substrate 101 set on a supporting portion 22 is dried by a heater 23, and the blade 27a is pressed against the surface of the liquid layer 102 as it is relatively rotated or moved. Thus, a liquid material 102a can be smoothed by the blade 27a and a centrifugal force produced by the rotation.

The present embodiment can also provide the same effects as those of the first embodiment. Specifically, a reduction in volume may sometimes cause formation of a hollow 104b in a surface 104a of a film 104 in each of trenches 101a. By the smoothing operation of the smoothing device 27, however, the liquid material on the surface is dried as it flows, so that the film thickness can be made uniform. As compared with the case where the surface solidifies first, therefore, the material becomes smoother as it solidifies. Thus, the thickness can be ensured even at shoulder portions 101c of each trench 101a where the film is easily thinned, in particular, so that formation of a thin film portion is retarded. Since the substrate 101 is rotated as the liquidity improvement process and drying process are performed, moreover, the liquid material 102a can be smoothed by the centrifugal force.

The invention is not limited to the embodiments described above and may be embodied in a variety of other forms. In each of the embodiments described herein, for example, the drying device 20 is designed to perform drying by heating. Alternatively, however, drying may be performed under reduced pressure, for example. Also in this case, the hollow depth can be reduced to ensure the film thickness in such a manner that the drying speed is reduced to control the surface solidification speed by increasing the decompression level in stages.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A film-forming apparatus comprising:
a coating unit which introduces a liquid material to a substrate with a groove and fills the liquid material into the groove, thereby forming a liquid layer;
a drying unit which solidifies the liquid layer by drying; and
a vapor supply unit which applies a vapor to a surface of the liquid layer during the drying.

2. A film-forming apparatus comprising:
a coating unit which introduces a liquid material to a substrate with a groove and fills the liquid material into the groove, thereby forming a liquid layer;
a drying unit which solidifies the liquid layer by drying; and
a acoustic radiation unit which applies an acoustic wave to a surface of the liquid layer during the drying.

3. A film-forming apparatus comprising:
a coating unit which introduces a liquid material to a substrate with a groove and fills the liquid material into the groove, thereby forming a liquid layer;
a drying unit which solidifies the liquid layer by drying; and
a smoothing unit which relatively moves in contact with a surface of the liquid layer during the drying, thereby smoothing the surface.

4. The film-forming apparatus of claim 1, wherein the drying is performed by heating at a temperature varied in stages.

5. The film-forming apparatus of claim 2, wherein the drying is performed by heating at a temperature varied in stages.

6. The film-forming apparatus of claim 3, wherein the drying is performed by heating at a temperature varied in stages.
